(19) United States
(12) Patent Application Publication
(10) Pub. No.: US 2010/0224110 A1
(43) Pub. Date: Sep. 9, 2010

(54) Seed Meter And Seed Disk With Peripheral Edge Seed Pick-Up

(76) Inventor: Nathan A Mariman, Geneseo, IL (US)

Correspondence Address: DEERE & COMPANY, ONE JOHN DEERE PLACE, MOLINE, IL, 61265, US

(21) Appl. No.: 12/399,173

(22) Filed: Mar. 6, 2009

(51) Int. Cl. A01C 19/00

(52) U.S. Cl. 111/11

(57) ABSTRACT

A seed meter with a flat seed disk with seed apertures on the peripheral edge of the disk results is provided. The seed pick-up on the disk edge enables a more predictable seed trajectory thereby improving the accuracy of seed spacing. With seed pick-up on the disk periphery, the seed reservoir in the meter housing is located rearward of the disk as opposed to the side of the disk, resulting in a narrowing of the meter housing, making it easier to package two meters close together for twin row planting or to lower the meter in the row unit, reducing the seed drop distance. With improved seed placement accuracy, the planter travel speed can be increased. Further efficiency is gained by a vacuum clean-out of the seed meters, reducing the time required to change seed type or variety.

### FIELD OF THE INVENTION

The present invention relates to a seed meter for a planter or seeder and in particular to a seed meter having a metering disk with apertures on the peripheral edge of the disk to adhere seeds thereto.

### BACKGROUND OF THE INVENTION

A common form of planter utilizes a vacuum disk seed meter for each row unit of the planter. One example of such is shown in U.S. Pat. No. 5,170,909. There, a seed disk is rotated past a pool of seeds on one side thereof. A plurality of seed cells formed by recesses in the surface of the seed disk at one or more circumferential rows of holes adjacent the outer periphery of the seed disk mechanically accelerate and eventually capture therein individual seeds from the seed pool. The individual seeds are held within the cells by a pressure differential created by a vacuum source coupled to the inside of the housing on the opposite side of the seed disk until the cells reach a discharge area. At the discharge area, the effects of the vacuum are cut off so as to release the individual seeds from the cells for discharge through a chute at the bottom of the housing to a seed furrow below. A positive pressure on the seed side of the disk can be used in place of the vacuum on the opposite side.

While such seed meters function well, improvements can be made that will help to improve the crop yields and improve the planting efficiency. For example, with some crops, precise spacing of the seeds in the seed trench can improve crop yields. How the seed is released from the seed disk impacts the seed trajectory through the seed tube and the seed's ultimate placement in the seed trench. Likewise, the distance the seed drops from the seed meter to the trench will also impact the seed spacing accuracy. The shorter the seed drop, the better the control in the seed placement. Yields can also be increased with different row spacings to plant with a higher seed population. One example is twin row planting with two closely spaced seed rows. The width of current seed meters make it difficult to place two meters close together for twin row applications. Increased efficiency of planting can be accomplished with higher travel speeds during planting. However, with current seed meters, higher travel speeds decrease the accuracy of seed spacing.

### SUMMARY OF THE INVENTION

The seed meter of the present invention has a seed disk with seed apertures on the peripheral edge of the disk. This avoids having the seed fall across a portion of the seed disk face upon release. The result is a more predictable seed trajectory, improving the accuracy of seed spacing. With seed pick-up on the disk periphery, the seed reservoir in the meter housing can be located to the front or rear of the disk as opposed to the side of the disk, this narrows the meter housing, making it easier to package two meters close together for twin row planting. The narrower meter can also be placed lower in the row unit, reducing the seed drop distance. With improved seed placement accuracy, the planter travel speed can be increased. Further efficiency is gained by a vacuum clean-out of the seed meters, reducing the time required to change seed type or variety.

### BRIEF DESCRIPTION OF THE DRAWINGS

FIG. 1 is a side view of a planter row unit with the meter of the present invention;

FIG. 2 is a perspective view of the seed meter disk showing the peripheral edge of the disk;

FIG. 3 is an enlarged, fragmentary perspective view of the opposite side of the seed disk from what is shown in FIG. 2;

FIG. 4 is a perspective view of the one member of the meter housing illustrating the vacuum channel and seal as well as the doubles eliminator;

FIG. 5 is an enlarged side view of the disk together with the seed singulator illustrating the interaction therebetween;

FIG. 6 is a side view of the seed singulator as viewed from the right in FIG. 5;

FIG. 7 is a perspective view of the seed meter illustrating the other housing member and vacuum clean-out; and

FIG. 8 is a schematic illustration of the vacuum clean out system.

### DESCRIPTION

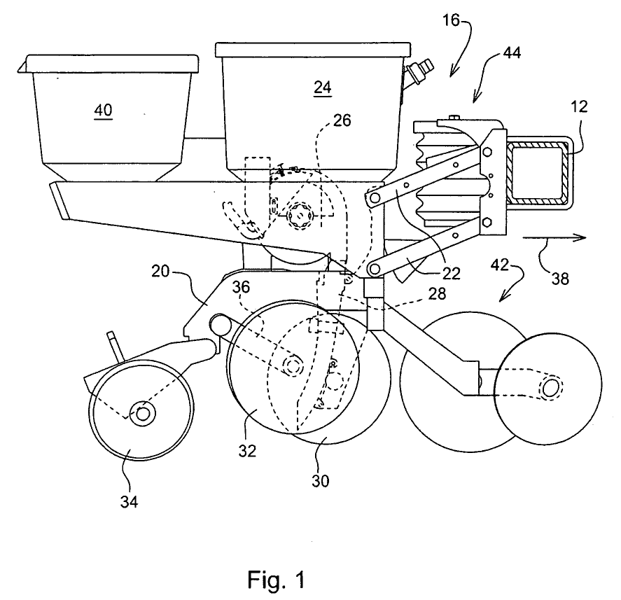

With reference to FIG. 1 a planter row unit 16 is shown mounted to transversely extending tool bar 12 in a conventional manner. The row unit 16 is provided with a central frame member 20 coupled to the tool bar by a parallelogram linkage 22 to enable vertical relative movement between the row unit and the toolbar in a known manner. Seed is stored in seed hopper 24 and provided to a seed meter 26. The seed meter singulates seed from a seed pool and drops the individual seeds through a seed tube 28 into a planting furrow. The furrow is formed in the soil by furrow opener disks 30. Gauge wheels 32 control the depth of the furrow and closing wheels 34 close the furrow over the seed. The gauge wheels 32 are mounted to the frame member 20 by arms 36. The row unit 16 further includes a chemical hopper 40, a row cleaner attachment 42 and a down force generator 44. The toolbar and row unit are designed to be move over the ground in a forward working direction identified by the arrow 38. Multiple row units 16 are transversely spaced along and mounted to the toolbar 12. The row unit 16 is shown as an example of the environment in which the meter of the present invention is used. The seed meter of the present invention can be used in any of a variety of planting units.

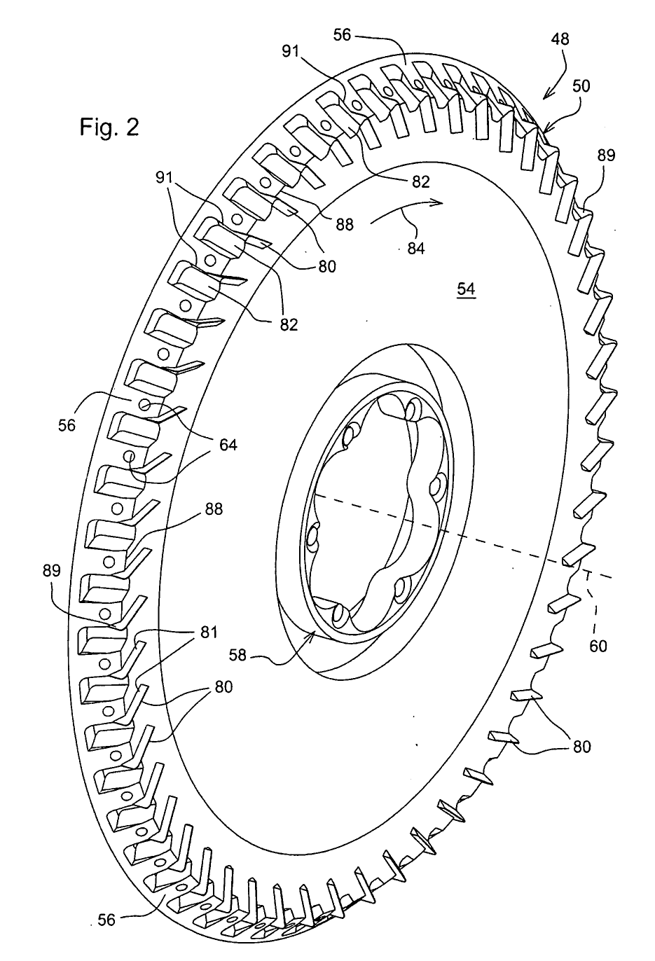

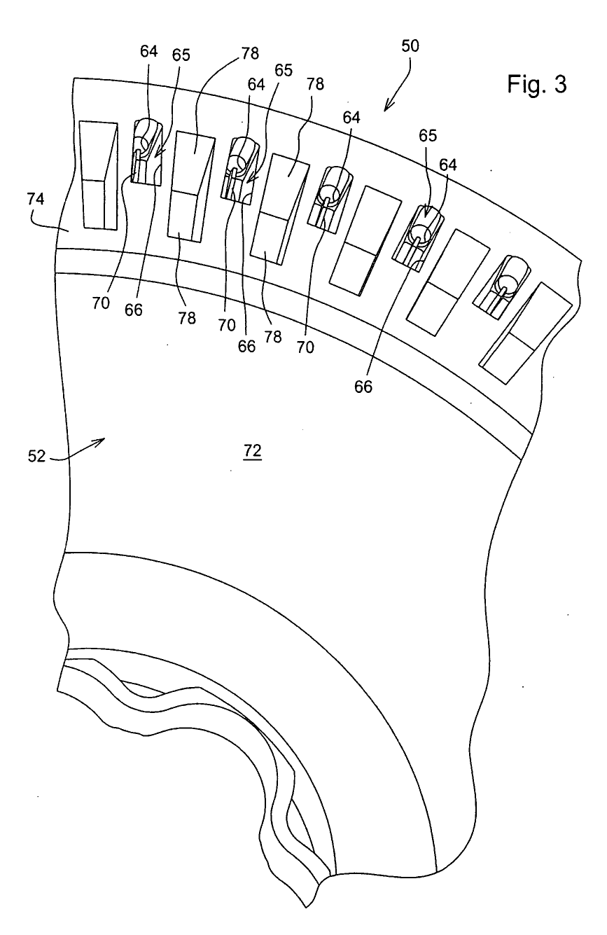

The seed meter 26 includes a seed disk 48 formed of circular member 50 (FIG. 2). The circular member 50 has a first or vacuum side 52 (FIG. 3) and a second or opposite side 54. (The use of the terms “vacuum side” and “opposite side” as applied to the disk is used solely to distinguish the two sides from one another and are not intended to limit the scope of the invention. For example, as described below, a vacuum is used to adhere seed to the circular member. A positive pressure could be used in place of the vacuum.) A peripheral edge 56 at the circumference of the circular member extends axially relative to the vacuum and opposite sides of the circular member. The circular member includes a central hub portion 58 by which the disk 48 is mounted to the meter drive for rotation about an axis 60. A plurality of apertures 64 on the peripheral edge 56 are formed by passages 65 that extend through the circular member 50 to openings 66 on the first, or vacuum, side 52 of the circular member. See FIGS. 2 and 3. A rib 70 is disposed in each passages to partially block the associated aperture 64 to prevent smaller seeds from lodging in the apertures.

On the vacuum side 52 of the circular member there is an intermediate portion 72 extending radially from the drive hub to an outer annular portion 74 adjacent the peripheral edge. The outer annular portion 74 is axially raised from the intermediate portion 72 (FIG. 3). The openings 66 are located in the raised outer ring or annular portion 74 forming an circular array of openings on the vacuum side of the circular member. Between each of the openings 66, a recess 78 is formed in the raised outer annular portion. Likewise, between each aperture 64 in the peripheral edge 56, a recess or groove 82 is formed. The circular member 50 rotates in the direction shown by the arrow 84. Features on the second side of the circular member, shown in FIG. 2 a fins 80 extending axially form confronting faces 81 in the direction of rotation. The confronting faces engage and agitate seed in the seed reservoir. In the embodiment show, the fins continue around the corner 88 at the connection of the peripheral edge and the second side forming a feature 89 radially extending from the peripheral edge. The features 89 follow the apertures 64 in the direction of rotation 84 at the forward edge 91 of each recess 82. As an alternative, the features forming the confronting faces 81 could be recesses in the second side of the circular member 50.

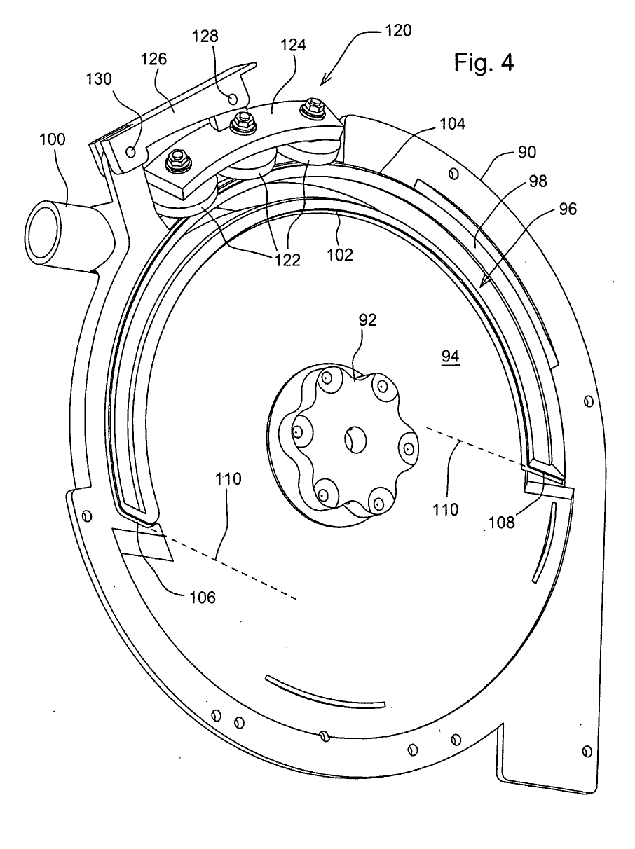

The seed meter housing consists of the first and second members 90, 150, the first member 90 is shown in FIG. 4. The first housing member carries a drive hub 92 that mates with the central hub 58 of the circular member 50. Drive hub 92 is coupled to a drive mechanism (not shown). The circular member 50 is mounted to the first housing member 90 with the vacuum side 52 facing the inner surface 94 of the first housing member. The first housing member 90 is formed with an arcuate vacuum channel 96 which is open to the circular array of openings 66 in the circular member 50. A resilient seal 98 around the perimeter of the vacuum channel 96 engages the axially raised outer annular portion 74 of the circular member 50 to prevent or reduce air flow therebetween. The vacuum channel has radially spaced inner and outer sides 102 and 104. A leading end 106 and a trailing end 108, relative to the direction of rotation, join the inner and outer sides of the vacuum channel. The leading and trailing ends of the vacuum channel are inclined or angled relative to the radial direction as shown by the broken lines 110. The angled ends of the vacuum channel allow for a transition of the vacuum pockets over the seal at the ends of the vacuum channel. This eliminates harmonic vibration of the seal 98 that occurs with radially oriented channel ends, parallel to the radial sides of the openings 66. The seal 98 is formed to fit the vacuum channel and has first and second arcuate segments along the radially spaced inner and outer sides 102 and 104 of the vacuum channel and first and second end segments therebetween that are inclined to the radial direction defined by the arcuate segments. The vacuum channel 96 he is coupled to a vacuum port 100 which in turn is connected to a vacuum pump to provide a vacuum or lower pressure in the vacuum channel 96, creating a pressure differential across the apertures 64 in the seed disk.

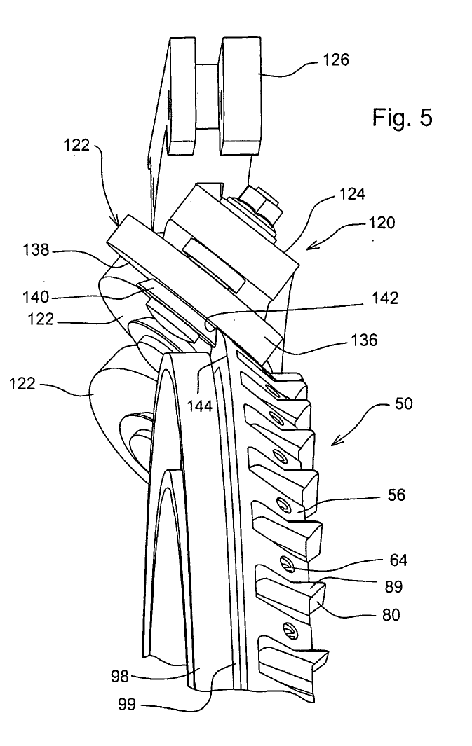

With reference to FIGS. 4, 5 and 6, a seed singulator 120 is shown and described. The seed singulator includes three rotating members such as rollers or wheels 122 rotatably mounted to a carrier 124. The carrier 124 is movably mounted to a support arm 126 at the pivot 128. This allows the carrier to adjust itself such that all three of the rollers 122 remain in contact with the circular member 50. The support arm 126 is in turn movably mounted to the housing member 90 at the pivot 130. This allows the rollers 122 to adjust for runout of the circular member 50. That is, to adjust for the circular member not being perfectly round and/or the axis of rotation 60 not being perfectly in the center of the circular member 50. As shown in FIG. 5, the peripheral edge 56 of the circular member 50 is not cylindrical about the axis 60 but is inclined radially inward from the first, or vacuum, side 52 toward the second, or opposite, side 54. The inclined edge 56 is preferred but the benefits of the invention can be obtained with a cylindrical peripheral edge as well. The rollers 122 have a main portion 136 that is generally cylindrical in shape. The bottom side 138 of the rollers engage the peripheral edge 56 of the disk member. The roller partial covers the apertures 64 to push the seeds slightly off the apertures so that if two or more seeds are adhered to any one aperture, the extra seeds are removed. A conically shaped projection 140 extends from the bottom side 138 of the rollers 122 and forms a groove 142 into which the corner 144 of the circular member is seated. By positioning the disk corner in the groove, the disk and rollers maintain engagement regardless of the tolerances of the disk and meter housing and regardless of dynamic conditions of the planter row unit. Also, in FIG. 5, a lip 99 of the seal 98 is shown engaging the vacuum side of the circular member 50.

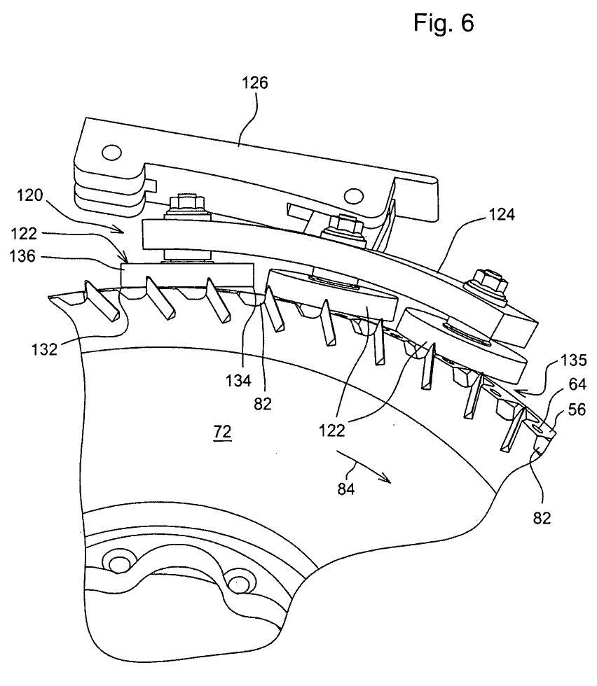

With reference to FIG. 6, the engagement between the rollers 122 and the circular member 50 is shown in greater detail. The rollers are mounted at slight incline to the circular member 50 such that the leading edge 132 of the roller, that is the first edge of the roller to contact the circular member relative to the direction of rotation, is closer to the circular member than the trailing edge 134 of the rollers. This results in a noticeable gap 135 between the roller trailing edge and the disk 48 that is not present at the leading edge. This orientation of the roller relative to the disk reduces the likelihood of seed fragments becoming lodged between the roller and circular member by providing an increasing gap between the two in the direction of rotation.

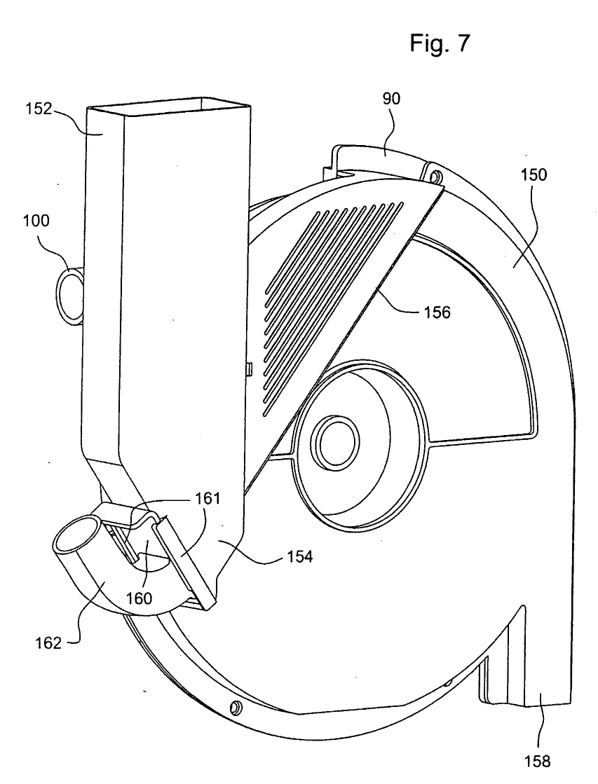

The assembled seed meter housing is shown in FIG. 7 with the housing second member, or cover, 150. The cover 150 includes a seed supply chute 152 through which seed is supplied to the meter. The lower end 154 of the seed supply chute forms a seed reservoir along the peripheral edge and partially on the side 54 of the circular member. A brush or other seal member (not show) is carried by the cover along the line 156 and engages the second side of the circular member to return seeds removed by the seed singulator back to the seed reservoir. After the seed is released from the meter disk, the seed drops through the discharge chute 158 into the seed tube 28 and to the furrow in the soil below.

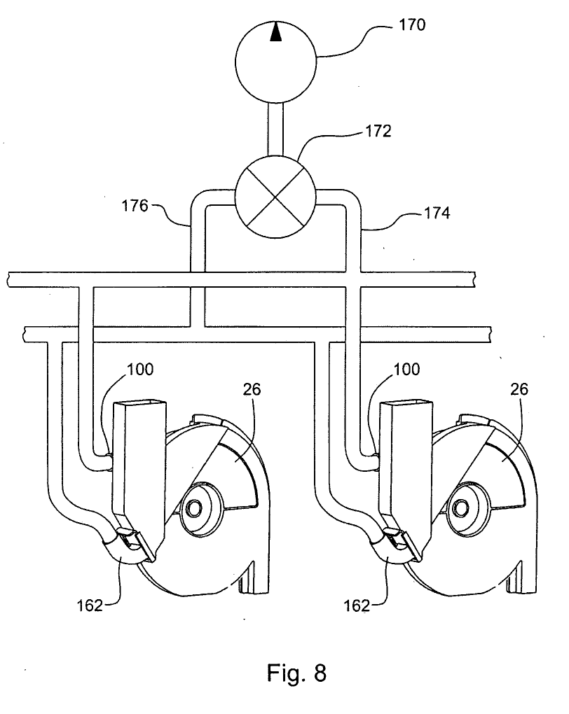

A removable door 160 is located at the bottom of the seed reservoir to assist in cleaning unused seed from the reservoir when the operator wishes to change seed type or variety. The door edges fit into slots 161 formed in the housing cover. By removing the door 160, remaining seed will fall from the reservoir. The door 160 is shown with an optional vacuum port 162 that can be connected to a vacuum source to remove the excess seed without the need to manually remove the door 160 from each seed meter of each row unit. The schematic drawing of FIG. 8 illustrates the vacuum system. The vacuum pump 170 is connected to a valve 172 that is selectively switched between normal planting operation and clean-out. During normal planting operation, the valve directs the vacuum to line 174 which in turn is in communication with the vacuum ports 100 of each seed meter. This supplies vacuum, or reduced air pressure, to the vacuum channels of each meter and thereby to the apertures 64 in the circular members to allow the pick-up of seeds from the seed reservoir. For clean-out, the valve 172 is switched, connecting the vacuum to line 176 which is in communication with vacuum ports 162 in the doors 160. The vacuum thus removes the seed from the reservoirs. If the vacuum pump 170 does not have sufficient capacity to clean all meters simultaneously, the line 174 can be coupled to a manifold with multiple valves to sequentially clean out groups of meters at a time.

As with other pressure differential seed meters; while the present invention has been shown and described as using a vacuum, it is possible to use a positive air pressure to retain the seeds on the circular member 50 and the claims which follow should be interpreted to include a positive pressure system wherein the pressure in the seed reservoir is higher than the pressure in the vacuum channel unless specifically precluded by the claim language.

Having described the preferred embodiment, it will become apparent that various modifications can be made without departing from the scope of the invention as defined in the accompanying claims.

The invention claimed is:

1. A seed disk for an air pressure seed meter comprising:
a circular member having a first side, a second side and a peripheral edge, the circular member adapted for rotation about an axis with the peripheral edge in communication with a source of seeds; and
a plurality of passages in said circular member extending from apertures in the peripheral edge of the circular member to openings in the first side of the disk.

2. The seed disk of claim 1 wherein the peripheral edge is inclined relative to the axis of rotation.

3. The seed disk of claim 2 wherein the peripheral edge is inclined radially inwardly relative to the axis of rotation in a direction from the first side to the second side.

4. The seed disk of claim 1 further comprising a plurality of recesses in the peripheral edge.

5. The seed disk of claim 3 further comprising features extending radially from the peripheral edge adjacent said second side of the circular member and located rearward of each aperture relative to a direction of rotation.

6. The seed disk of claim 1 further comprising features on the second side forming a confronting faces in the direction of rotation.

7. The seed disk of claim 6 wherein the feature on the second side is a raised feature from the second side.

8. The seed disk of claim 1 further comprising a raised rib in each of the passages blocking a portion of the associated aperture.

9. The seed disk of claim 1 wherein the circular member is a solid disk having a central hub portion, an intermediate portion and an outer annular portion adjacent the peripheral edge that is axially raised from the intermediate portion on the first side, and wherein the passages open to the first side of the disk in the outer annular portion.

10. A seed meter assembly comprising:
a seed disk having a circular member with a first side, a second side and a peripheral edge, and a plurality of passages in the circular member extending from apertures in the peripheral edge of the circular member to openings in the first side of the disk arranged in a circular array; and
a housing in which said seed disk is mounted for rotation about an axis, the housing forming a reservoir for seed through which the peripheral edge of the seed disk rotates and the housing forming an arcuate vacuum channel arranged in juxtaposition to the circular array of openings in the first side of the disk.

11. The seed meter assembly of claim 10 further comprising a vacuum port at a lower end of the reservoir adapted to couple the reservoir to a vacuum source to facilitate removal of seed from the reservoir by vacuum.

12. The seed meter assembly of claim 11 further comprising a vacuum pump selectively connectable to either the vacuum chamber or the seed reservoir.

13. The seed meter assembly of claim 10 further comprising:
a seed singulator assembly carried by the housing having at least one wheel engaging the circular member and being in close proximity to the apertures to engage seed adhered to the apertures to remove excess seed therefrom, the at least one wheel being mounted to a carrier that is movably mounted to the housing whereby the wheel follows a surface of the circular member.

14. A seed meter assembly comprising:
a seed metering member having a first side and a second side, the metering member including a plurality of passages therein opening to the first side of the metering member in a circular array of openings; and
a housing in which said metering member is mounted for rotation about an axis, the housing forming an arcuate vacuum channel arranged in juxtaposition to the circular array of openings in the metering member and adapted to be coupled to a vacuum source, the vacuum channel having radially spaced inner and outer edges and leading and trailing ends in the direction of rotation of the metering member, the leading and trailing ends of the vacuum channel being arranged at an angle to the radial direction.

15. A seal for an arcuate vacuum chamber of a seed meter housing comprising first and second arcuate segments radially spaced from one another and connected to one another by first and second end segments, the end segments extending in a direction that is inclined to a radial direction defined by the first and second arcuate segments.

16. A seeding machine comprising:
a seed meter assembly having a seed metering member with a plurality of passages therein and a housing in which said metering member is mounted for rotation about an axis, the housing forming a reservoir to hold a supply of seed in contact with the passages in the metering member as the passages move through the reservoir upon rotation of the metering member, the housing having a vacuum port at a lower end of the reservoir adapted to couple the reservoir to a vacuum source to facilitate removal of seed from the reservoir by vacuum.

17. The seeding machine of claim 16 wherein the housing further includes a vacuum chamber arranged in juxtaposition to the passages in the metering member and a vacuum port adapted to couple the vacuum chamber to a vacuum source and further comprising a vacuum pump selectively connectable to either the vacuum chamber or the seed reservoir.

18. A seed meter assembly comprising:
a seed metering member having apertures for retaining seed thereon;
a housing in which said metering member is mounted, the housing forming a reservoir to hold a supply of seed in contact with the apertures in the metering member; and
a seed singulator assembly carried by the housing having at least one rotating member engaging the metering member and being in close proximity to the apertures to engage seed adhered to the apertures to remove excess seed therefrom, the at least one wheel being mounted to a carrier that is movably mounted to the housing whereby the wheel follows a surface of the metering member.

19. The seed meter of claim 18 wherein the singulator includes at least two said rotating member mounted to the carrier and the carrier is movably mounted to a support arm which is in turn movably mounted to the housing.

20. The seed meter of claim 18 wherein each of the singulator rotating members has a portion forming a groove into which an edge corner of the seed metering member is seated.

21. The seed meter of claim 18 wherein a radially extending side surface of the rotating member engages the metering member and wherein the rotating member is oriented relative to the metering member such that a leading edge of the rotating member side surface is closer to the metering member than a trailing edge of the rotating member side surface.
